(19) United States
(12) Patent Application Publication
(10) Pub. No.: US 2014/0316465 A1
(43) Pub. Date: Oct. 23, 2014

(54) "Apparatus and Method For Spinal And/or Neck Decompression"

(71) Applicant: Milly Products, LLC, Pittsburgh, PA (US)

(72) Inventors: Stephen G. Robinson, Ligonier, PA (US); Ilana Diamond, Pittsburgh, PA (US); Abigail R. Foster, Pittsburgh, PA (US)

(21) Appl. No.: 14/208,724

(22) Filed: Mar. 13, 2014

Related U.S. Application Data
(60) Provisional application No. 61/782,753, filed on Mar. 14, 2013.
(60) Provisional application No. 61/926,645, filed on Jan. 13, 2014.

(51) Int. Cl. A61G 5/10

(52) U.S. Cl. CPC A61G 5/10
USPC 606/242

(57) ABSTRACT

A device for relieving back and/or neck pain of a seated user through spinal decompression includes a frame, a seat base connected to the frame, and a seat back connected to the frame. The seat base has a front portion and a rear portion, with the seat back extending from the rear portion of the seat base. At least one of the seat base and the seat back is movable relative to the other of the seat base and the seat back to increase a distance between the seat base and the seat back to decompress a spine of the seated user.

### CROSS REFERENCE TO RELATED APPLICATIONS

This application claims priority to a provisional U.S. Application No. 61/782,753, filed Mar. 14, 2013, entitled “Apparatus and Method for Spinal Decompression” and provisional U.S. Application No. 61/926,645, filed Jan. 13, 2014, entitled “Apparatus and Method for Spinal Decompression”, both of which are hereby incorporated by reference in their entirety.

### BACKGROUND OF THE INVENTION

1. Field of the Invention

The present invention relates, in general, to methods and devices for spinal decompression, and, in particular, to methods and devices for relieving or addressing back and/or neck pain through the use of spinal decompression.

2. Description of Related Art

Back and/or neck pain, especially lower back pain, is one of the chief medical complaints of adults. According to the American Academy of Orthopedic Surgeons, 30% of the adult population reported lower back pain in the past year, with 15% of the adult population seeking treatment from their physicians. One of the chief causes of back and/or neck pain is spinal compression.

Spinal compression and the associated pain are treated through a number of techniques. These include chiropractic manipulation, physical therapy, massage, prescription and non-prescription pharmaceuticals and devices. The devices include at-home inversion tables, expandable and/or inflatable back braces, supine traction devices, weighted stretchers, thermal treatments, and nerve stimulation. Devices configured for use in an office setting include supine traction devices. Specific exercises have also been developed in combination with devices such as inflatable balls and foam rollers.

Chiropractic manipulation, physical therapy, and massage require trips to a healthcare professional and are not practical for daily use, in addition to being expensive. Pharmaceutical remedies are often ineffective, may have serious side effects, and, in some cases, can be addictive. The current devices for home use are ineffective and are not user friendly. Many of them must be used in the supine position, thereby limiting the user's ability to perform other work or leisure activities while receiving treatment.

### SUMMARY OF THE INVENTION

Accordingly, and generally, provided is a device for relieving back and/or neck pain of a seated user through spinal decompression.

In one preferred and non-limiting embodiment, the device may include a frame, a seat base connected to the frame, and a seat back connected to the frame. The seat base may have a front portion and a rear portion, with the seat back extending from the rear portion of the seat base. At least one of the seat base and the seat back may be movable relative to the other of the seat base and the seat back to increase a distance between the seat base and the seat back for decompressing a spine of the seated user.

In accordance with another preferred and non-limiting embodiment, at least a portion of the seat back may rise relative to the seat base. Alternatively, at least a portion of the seat base may lower relative to the seat back. In yet another alternative, the rear portion of the seat base may lower relative to the front portion of the seat base. A first restraint may be configured for restraining hips of the user relative to the seat base, and a second restraint may be configured for restraining a torso of the user relative to the seat back. The first restraint may include at least one of an adjustable lap belt and an adjustable lap pad. The second restraint may include at least one of an adjustable torso supports for supporting the torso of the user and an adjustable torso strap for wrapping around the torso of the user. The first and second restraints may include a locking mechanism.

In accordance with a further preferred and non-limiting embodiment, the device may include arm rests for supporting the user's forearms. Additionally, the device may include a lower leg support for supporting the user's calves and an adjustable lumbar support in the seat back. A head/neck rest may be provided on the seat back. The head/neck rest may include at least one of an adjustable chin strap for supporting the user's chin and an adjustable pair of side supports for supporting the user's head. The head/neck rest may secure at least a portion of the head and/or neck of the user and may be movable relative to the seat back for decompressing the neck of the user.

In accordance with yet another preferred and non-limiting embodiment, the seat base and/or the seat back may tilt relative to the frame. A control panel may be provided for controlling the movement of the at least one of the seat base and the seat back relative to the other of the seat base and the seat back. The device may include at least one of a massager, a heater, and a cooling device. An actuator may be operatively coupled to at least one of the seat base and the seat back for moving the seat base or the seat back to increase a distance therebetween. The actuator may be an electric, a hydraulic, or a pneumatic device. The actuator may also be operatively coupled to the head/neck support.

In one preferred and non-limiting embodiment, the device may include a frame, a seat base connected to the frame, and a seat back connected to the frame. The seat base may have a front portion and a rear portion, with the seat back extending from the rear portion of the seat base. An actuator may be operatively coupled to one of the seat base and the seat back for moving the seat base or the seat back to increase a distance between the seat base and the seat back. The seat base and the seat back may tilt relative to the frame. Optionally, a first restraint may be configured for restraining the user's hips relative to the seat base, and a second restraint may be configured for restraining the user's torso relative to the seat back.

In yet another preferred and non-limiting embodiment, a method for relieving back and/or neck pain of a seated user through spinal decompression may include providing a chair having a frame, a seat base connected to the frame, and a seat back connected to the frame. The seat base may have a front portion and a rear portion, with the seat back extending from the rear portion of the seat base. The method may further include moving one of the seat base and the seat back relative to the other of the seat base and the seat back to increase a distance between the seat base and the seat back to decompress the spine of the seated user. Optionally, the method may also include restraining hips of the user with a first restraint and/or restraining the torso of the user with a second restraint. The first restraint may be configured for restraining the user's hips relative to the seat base, and the second restraint may be configured for restraining the user's torso relative to the seat back.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 illustrates a device for relieving back and/or neck pain of a seated user through the use of spinal decompression according to one embodiment of the present invention;

FIGS. 2A-2B illustrate a device for relieving back and/or neck pain of a seated user through the use of spinal decompression according to other embodiments of the present invention;

FIG. 3 illustrates a seat back for use with a device for relieving back and/or neck pain of a seated user through the use of spinal decompression in accordance with one embodiment of the present invention;

FIG. 4 illustrates a head/neck rest for use with a device for relieving back and/or neck pain of a seated user through the use of spinal decompression in accordance with one embodiment of the present invention;

FIGS. 5-17 illustrate various restraints for use with a device for relieving back and/or neck pain of a seated user through the use of spinal decompression in accordance with embodiments of the present invention;

FIG. 18 illustrates a control panel for use with a device for relieving back and/or neck pain of a seated user through the use of spinal decompression in accordance with one embodiment of the present invention;

FIGS. 19-22 illustrate a device for relieving back and/or neck pain of a seated user through the use of spinal decompression in accordance with one embodiment of the present invention;

FIG. 23 illustrates a device for relieving back and/or neck pain of a seated user through the use of spinal decompression in accordance with another embodiment of the present invention;

FIG. 24 illustrates a device for relieving back and/or neck pain of a seated user through the use of spinal decompression in accordance with another embodiment of the present invention;

FIGS. 25-27 illustrate a device for relieving back and/or neck pain of a seated user through the use of spinal decompression in accordance with another embodiment of the present invention;

FIG. 28 illustrates a device for relieving back and/or neck pain of a seated user through the use of spinal decompression in accordance with another embodiment of the present invention;

FIG. 29 illustrates a device for relieving back and/or neck pain of a seated user through the use of spinal decompression in accordance with a further embodiment of the present invention;

FIGS. 30-37 illustrate movement of a base portion of a device for relieving back and/or neck pain of a seated user through the use of spinal decompression in accordance with further embodiments of the present invention;

FIG. 38 illustrates tilting of a device for relieving back and/or neck pain of a seated user through the use of spinal decompression in accordance with another embodiment of the present invention; and

FIGS. 39-41 illustrate motorized movement of a device for relieving back and/or neck pain of a seated user through the use of spinal decompression in accordance with a further embodiment of the present invention.

### DETAILED DESCRIPTION OF THE INVENTION

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting. As used in the specification and the claims, the singular form of “a”, “an”, and “the” include plural referents unless the context clearly dictates otherwise.

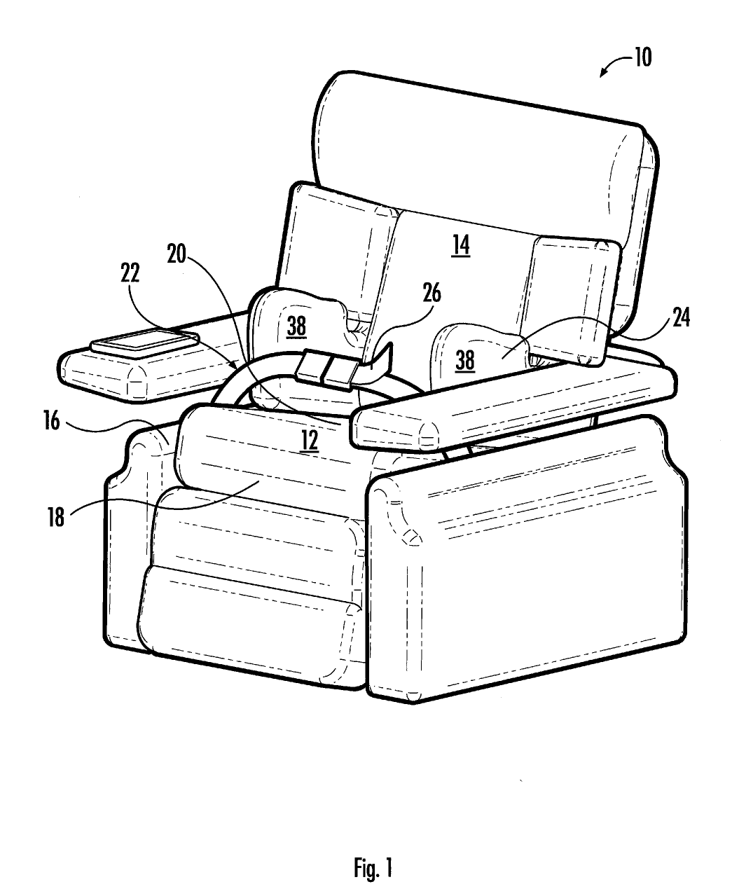

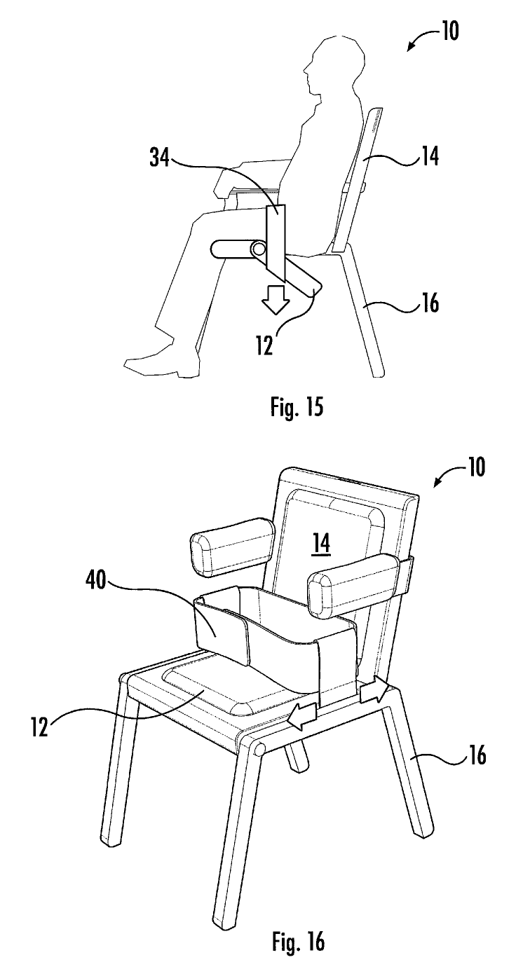

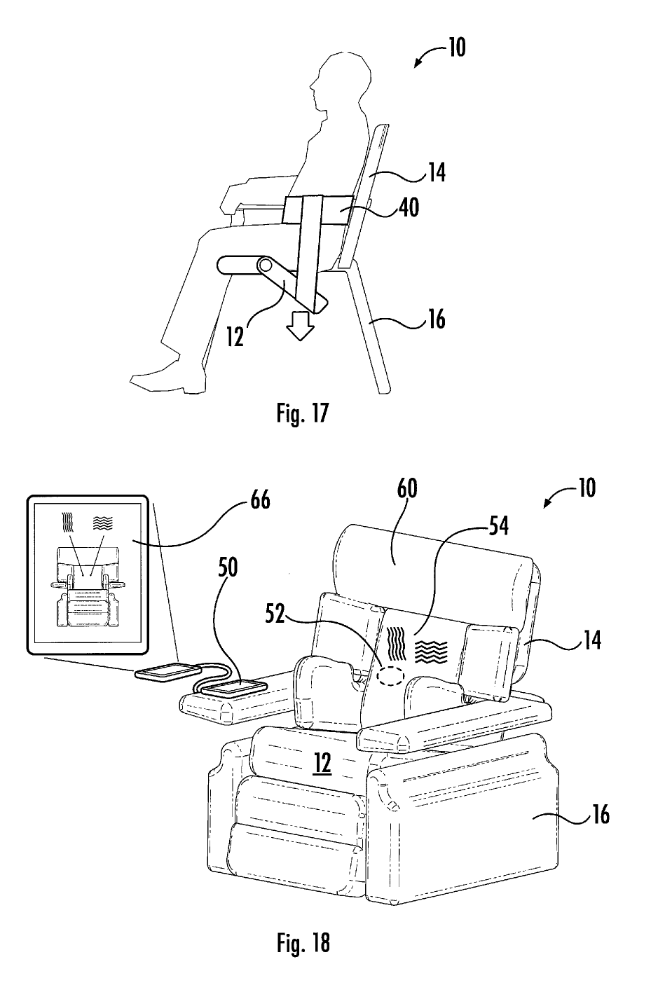

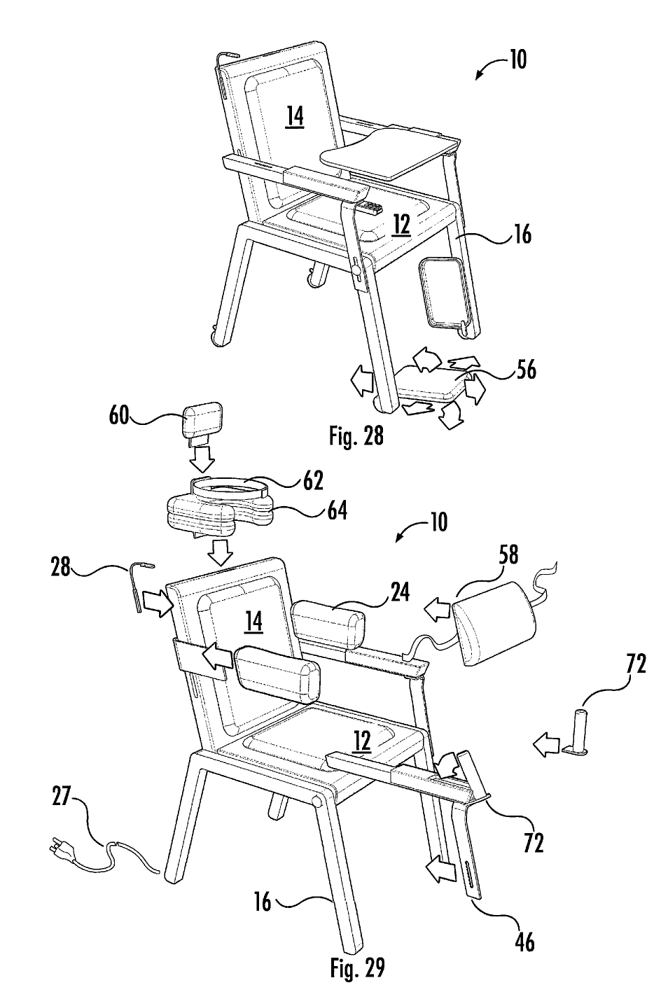

As discussed in detail hereinafter, the present invention is related to a device 10 for relieving or addressing back and/or neck pain of a seated user. Various preferred and non-limiting embodiments of the device 10 are illustrated in FIGS. 1-41, wherein the various components and parts of a device 10 in one preferred and non-limiting embodiment may be used in connection with or integrated with another preferred and non-limiting embodiment of the device 10.

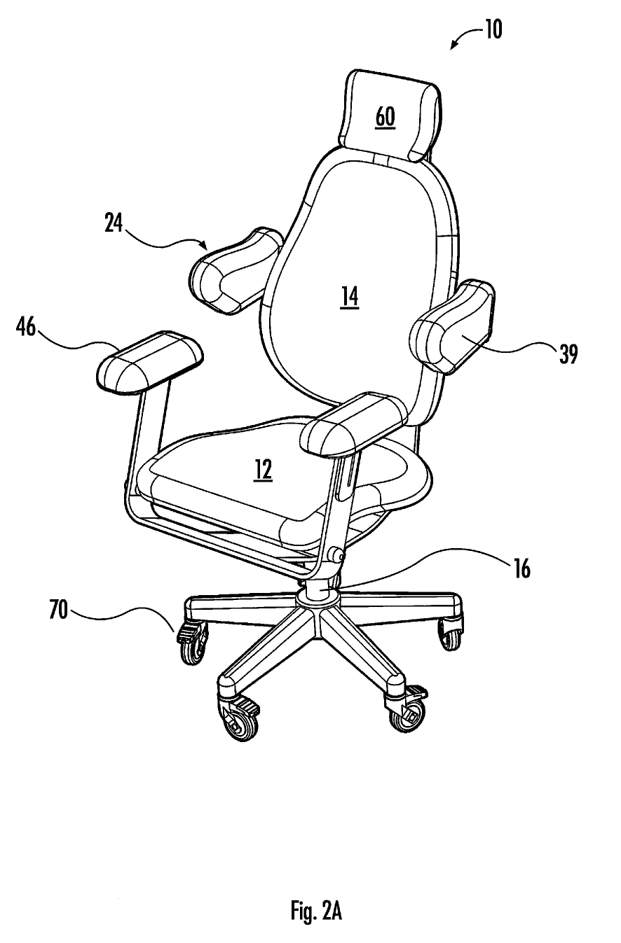

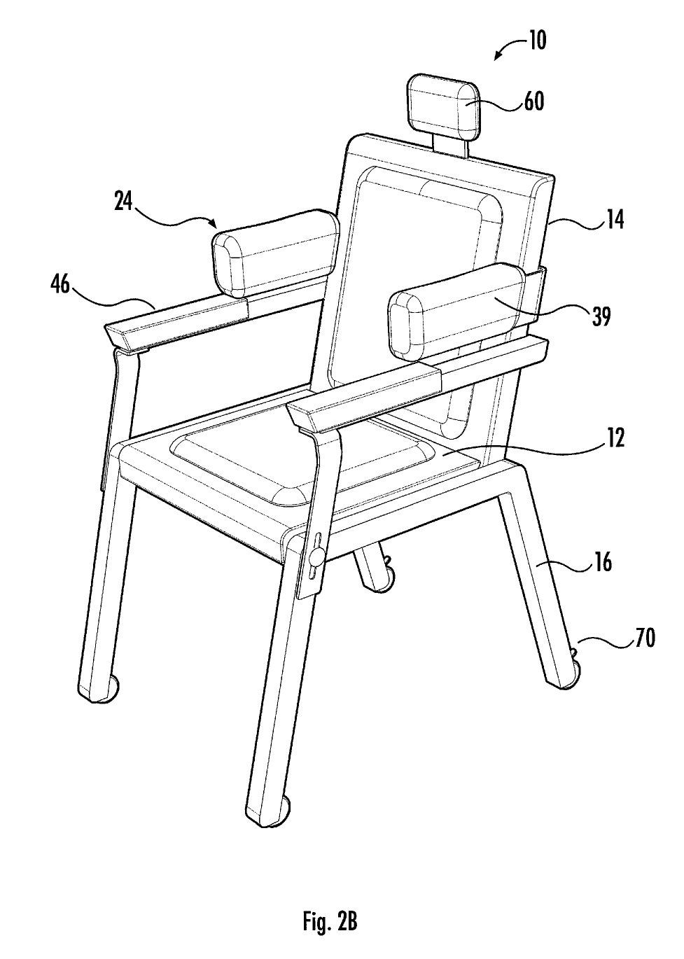

FIG. 1 illustrates one preferred and non-limiting embodiment of a device 10 for relieving or addressing back and/or neck pain of a seated user through the use of spinal decompression according to the principles of the present invention. In FIG. 1, the device 10 is embodied as a chair, such as a lounge chair. In another preferred and non-limiting embodiment shown in FIG. 2, the device 10 is embodied as an office chair. In either embodiment, the device 10 may have a soft supporting surface, such as foam, memory foam, or a similar soft material, to provide comfort to the user while in a seated position. The exterior of the device 10 may be covered with a protective natural or synthetic material, such as cloth or leather. The material may be textured to provide a frictional surface for preventing the user from sliding while using the device 10. One of ordinary skill in the art will appreciate that the preferred and non-limiting examples illustrated in FIGS. 1-2 are exemplary only, and that various other devices for supporting a seated user and relieving back and/or neck pain through spinal decompression are contemplated.

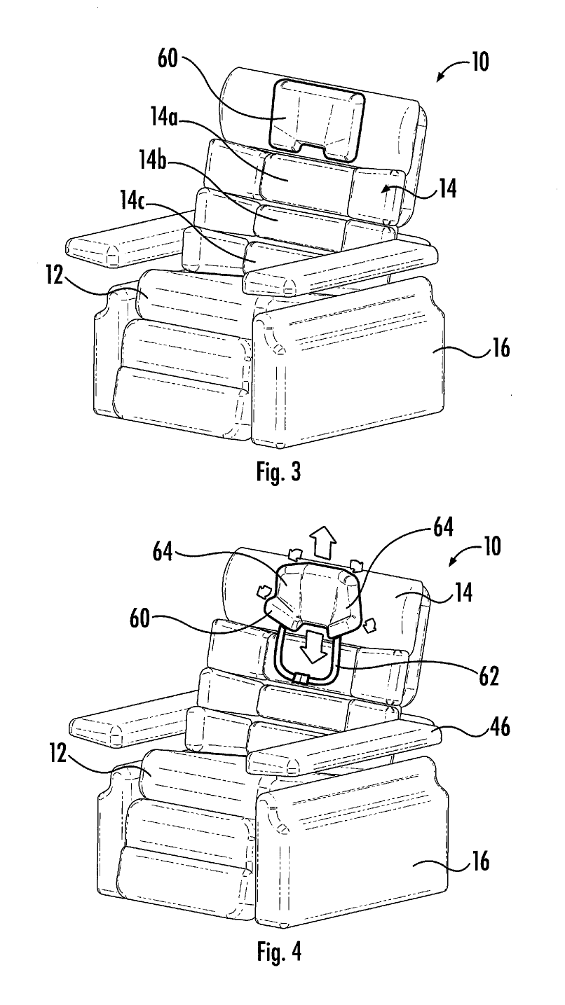

With continued reference to FIG. 1, the device 10 includes a seat base 12 for supporting the user in a seated position and a seat back 14 for supporting the back of a seated user. The seat base 12 and the seat back 14 are arranged on a frame 16. The seat base 12 has a front portion 18 and a rear portion 20. The seat back 14 extends upwardly relative to the rear portion 20 of the seat base 12. In one preferred and non-limiting embodiment, the seat back 14 may be arranged in a fixed angular orientation relative to the seat base 12. Alternatively, the seat back 14 may be movable relative to the seat base 12, such that the angle between the seat back 14 and the seat base 12 is adjustable. Optionally, the seat base 12 and seat back 14 move substantially in unison to provide a tilted structure with respect to the frame 16. Additionally, the seat base 12 and the seat back 14 are movably adjustable relative to the frame 16 and to each other, as will be described hereinafter. The seat back 14 may be formed from a plurality of sections 14a-14c, as depicted in FIG. 3. Each of the sections 14a-14c may be movable independently of the remaining sections 14a-14c.

Movement of the components may be accomplished by a manual or power-assisted means. For example, a manual handle may be used to effect a manual movement of the device 10. In another preferred and non-limiting embodiment, an electric device, a hydraulic device, a pneumatic device, or a combination thereof, may be provided to effect power-assisted movement of the components. In yet another preferred and non-limiting embodiment, the components may be movable between multiple pre-determined positions, as will be described in greater detail hereinafter.

In another preferred and non-limiting embodiment, the device 10 further includes a pair of restraints, embodied in FIG. 1 as a first restraint 22 and a second restraint 24. Of course, it should be recognized that the device 10 may include only the first restraint 22 or the second restraint 24 (or, as discussed hereinafter, no restraint at all—instead relying upon the frictional interfaces between the user and the device 10.) In this embodiment, the first and second restraints 22, 24 restrain the user's body in a desired posture while in a seated position. With reference to FIG. 5, the first restraint 22 is in the form of a lap belt 26 to restrain the user's hips from movement relative to the seat base 12. The lap belt 26 has at least one strap that is configured to extend around the user's midsection. The lap belt 26 may be adjustable to conform to the shape of differently-sized users. The user may adjust the lap belt 26 by pulling on the at least one strap. Alternatively, the lap belt 26 may be provided with a retractable mechanism similar to a seat belt in an automobile, which automatically adjusts to the user's size.

In another embodiment, the first restraint 22 and/or the second restraint 24 may include a pressure-sensing, force-sensing, and/or timing mechanism or arrangement that facilitates the immediate disengagement of the restraints 22, 24 in certain conditions, e.g., sensing of a set level of pressure or force, sensing a specified movement, sensing a specified temperature, reaching a certain time period, sensing a sudden level of pressure or force, or the like, or powering down of some or all of the components of the device 10. In this manner, the device 10 may include this or any other safety mechanism or arrangement to permit the quick and effective disengagement of the restraints 22, 24 or powering down in certain conditions or situations. It is also envisioned that the pressure, force, movement, temperature, and/or timing levels or conditions may be pre-determined (e.g., factory settings) or configurable by the user. Such safety mechanisms and arrangements may be used in connection with any of the parts or components of the device 10, e.g., the seat base 12, the seat back 14, a head/neck rest 60, a tilt function, a heating/cooling function, a massaging function, and the like.

In one preferred and non-limiting embodiment, the lap belt 26 may have a pair of straps whose free ends can be connected by a locking mechanism 28. Alternatively, the lap belt 26 may be embodied as a single strap that engages a locking mechanism 28 provided on the seat base 12 or the frame 16. In an embodiment where the lap belt 26 is fixed to the frame 16 (FIG. 5), the lap belt 26 is provided with a tensioning mechanism 30. The tensioning mechanism 30 may be a spring that is attached to the frame 16 and the lap belt 26 to relieve the increase in tension across the user's lap if the seat base 12 is moved relative to the frame 16, as will be described in greater detail hereinafter. The locking mechanism 28 is engaged by the user once the user is seated on the seat base 12. When the position of the seat base 12 changes relative to the frame 16 and/or the seat back 14, the lap belt 26 restrains the user's hips in a substantially fixed position relative to the seat base 12, thereby providing downward pressure on the user. This downward pressure assists in the spinal decompression of the user when the seat back 14 of the device 10 is moved relative to the seat base 12, as will be described in greater detail hereinafter.

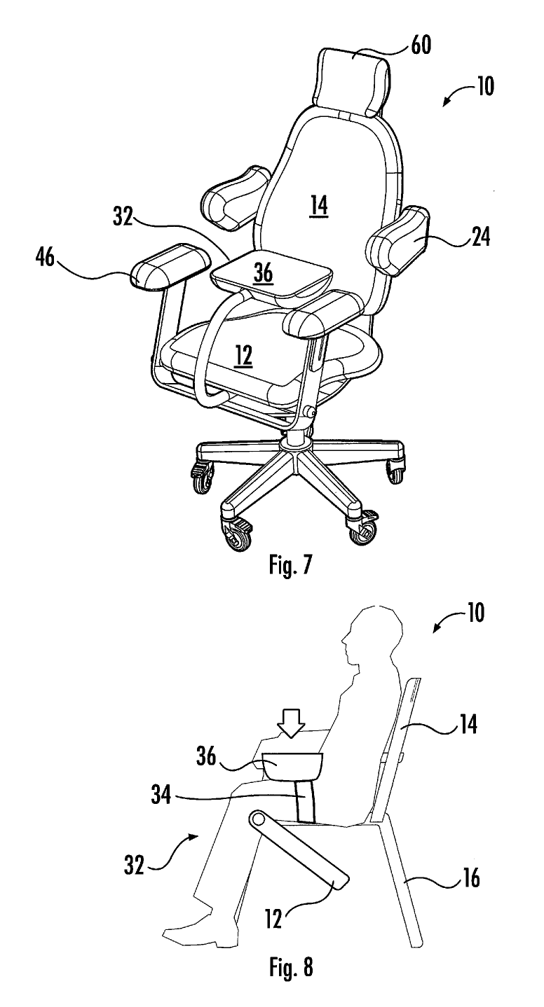

FIGS. 7-9 illustrate an additional feature that may be used instead of or in combination with the first restraint 22 (not shown) to support decompression of the seated user's spine. To restrain the user's lower body against movement relative to the seat base 12, a lap restraint 32 may be provided. The lap restraint 32 may be in the form of an adjustable belt 34 (shown in FIG. 8) that extends across the user's lap. Once in a seated position, the user secures the lap restraint 32 across his/her lap in a manner similar to how the lap belt 26 is secured. The lap restraint 32 may be adjustable in a front-back direction to adjust the position of the lap restraint 32 for differently sized users. In another embodiment, as shown in FIGS. 7-8, the lap restraint 32 is embodied as a lap pad 36 that is positionable over the user's lap area. The lap pad 36 may be padded to provide a soft support surface for the user's lap. The lap pad 36 may be removably attachable to a front or side portions of the seat base 12.

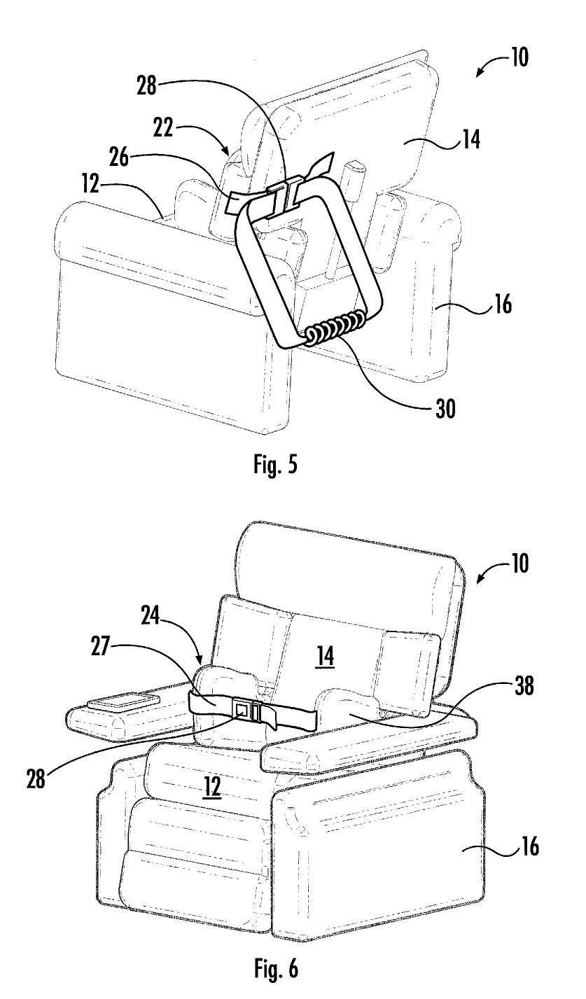

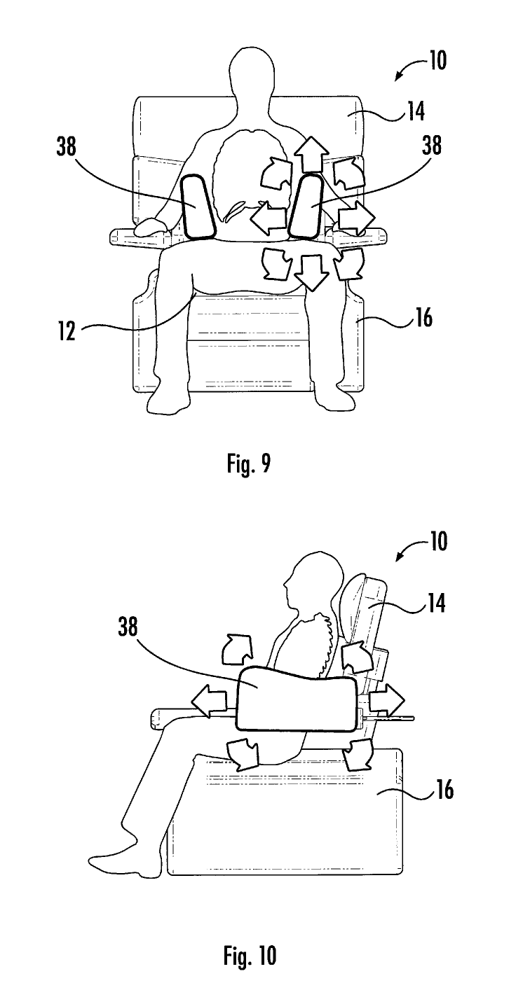

Referring back to FIG. 1, and in one preferred and non-limiting embodiment, the second restraint 24 is in the form of a torso supports 38 to restrain the user's torso from movement relative to the seat back 14. As the seat base 12 moves relative to the seat back 14, the second restraint 24 applies upward and/or inward pressure to the user's torso. The torso supports 38 have a pair of support members configured to extend around at least a portion of the user's torso. In another embodiment, the torso supports 38 may be embodied as a plurality of torso supports 38 that may correspond to different portions of the seat back 14. Alternatively, with reference to FIGS. 2A-2B, the second restraint 24 may be embodied as a pair of underarm bolsters 39 that are configured to be received in the area of the user's underarms. The underarm bolsters 39 support at least a portion of the user's weight as the seat base 12 is moved relative to the seat back 14. As shown in FIGS. 9 and 21, the torso supports 38 and the underarm bolsters 39 may be adjustable to conform to the shape of differently-sized users. The user may adjust the width of the support members of the torso supports 38 and the underarm bolsters 39 by pushing them toward or away from each other. Alternatively, the support members of the torso supports 38 and the underarm bolsters 39 may be spring-loaded such that they automatically adjust to the size of the user's torso. With reference to FIG. 6, the torso supports 38 may have a pair of straps 27 whose free ends are releasably connected with a locking mechanism 28. In yet another embodiment, the torso supports 38 and the underarm bolsters 39 may be inflatable to conform to the shape of the user's torso. The torso supports 38 and the underarm bolsters 39 are adjustable in a vertical direction, a horizontal direction, and/or a side-to-side direction depending on the size of the user and the amount of spinal decompression desired.

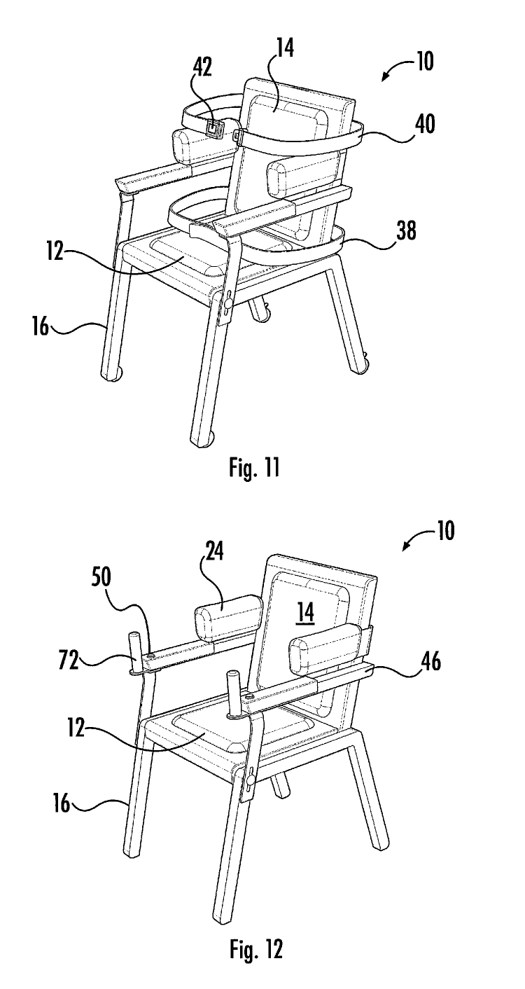

In another preferred and non-limiting embodiment shown in FIGS. 11, 13, and 14, the second restraint 24 may be formed as at least one torso strap 40. The torso strap 40 may have a pair of straps whose free ends can be connected by a locking mechanism 42. Alternatively, the torso strap 40 may be embodied as a single strap that engages a locking mechanism 42 (shown in FIG. 11) provided on the frame 16. In another embodiment, a plurality of torso straps 40 may be provided to correspond to a plurality of different portions of the seat back 14. In an embodiment where the torso strap 40 is fixed to the frame 16, the torso strap 40 is provided with a tensioning mechanism 44 (FIG. 14). The tensioning mechanism 44 may be a spring that is attached to the frame 16 and the torso strap 40 to relieve the increase in tension across the user's torso if the seat back 14 is moved relative to the frame 16, as will be described in greater detail hereinafter. The locking mechanism 42 is engaged by the user once the user is seated on the seat base 12 and his/her back rests against the seat back 14. When the position of the seat base 12 changes relative to the frame 16 and/or the seat back 14, the torso strap 40 restrains the user's torso in substantially fixed position relative to the seat back 14. The torso strap 40 may be provided separately or in combination with the torso supports 38 (FIG. 11). The torso supports 38, the underarm bolsters 39, and/or the torso strap 40 may be padded with a soft material, such as a foam material, to provide a comfortable resting surface for the user's torso and/or underarms. Alternatively, or in addition, the torso supports 38, the underarm bolsters 39, and/or the torso strap 40 may be covered in a high friction material to increase a frictional force with the user's torso and/or underarms.

With reference to FIG. 18, the device 10 is provided with a control panel 50 operative for controlling various features of the device 10. For example, the control panel 50 is used to control the power-assisted movement of various components of the device 10. The control panel 50 may be embodied as a touch screen panel. In another preferred and non-limiting embodiment, the control panel 50 has a plurality of control members, such as buttons and knobs that control the operation of the device 10. In yet another preferred and non-limiting embodiment, the control panel 50 may be embodied as a wireless panel that is operative for remotely controlling the functions of the device 10.

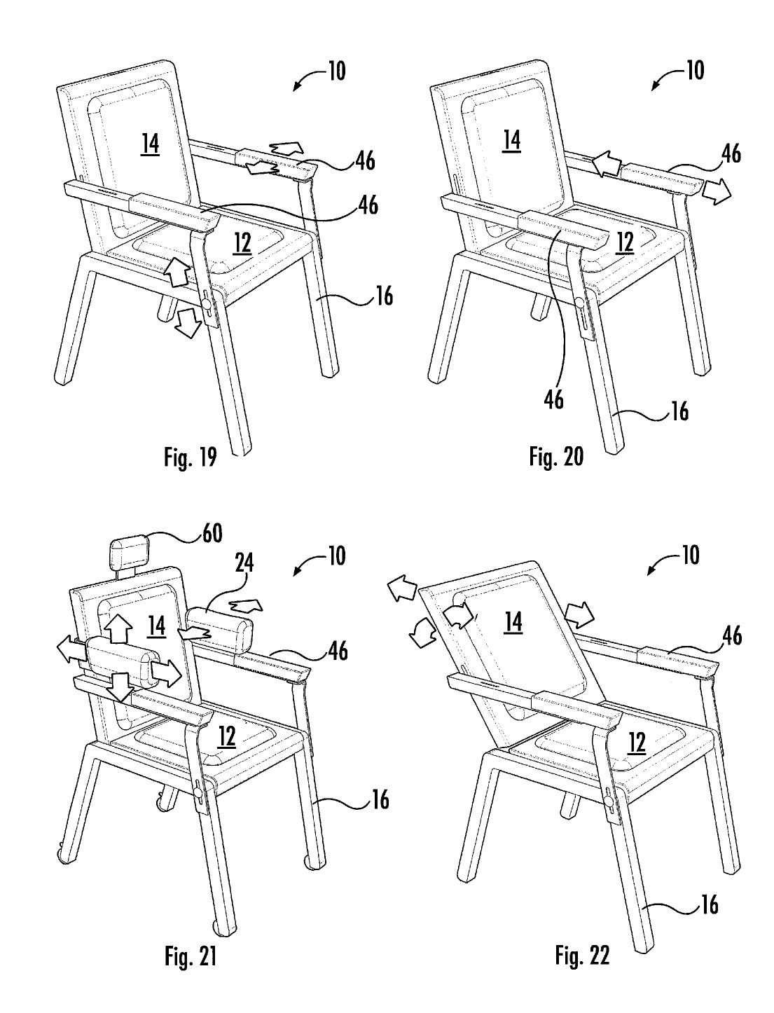

The device 10 may be provided with various accessories to increase the functionality of the device 10. For example, as shown in FIGS. 19-21, the device 10 further includes a pair of arm rests 46 for supporting the user's forearms while in a seated position. The arm rests 46 are provided on opposing sides of the seat base 12 and the seat back 14. The arm rests 46 may be attached to the frame 16, the seat base 12, or the seat back 14. In one preferred and non-limiting embodiment, the arm rests 46 are adjustable in a vertical direction. The arm rests 46 may also be adjustable in a front-back direction, or they may be pivotable in a side-to-side direction about a pivot point. Parallel side-to-side movement where the arm rests 46 are moved toward or away from each other is also contemplated. Movement of the arm rests 46 may be accomplished by a manual or power-assisted movement. For example, an electric device, a hydraulic device, a pneumatic device, or a combination thereof, may be provided to effect power-assisted movement of the arm rests 46. Such power-assisted movement is controlled by inputs received from the control panel 50. In one preferred and non-limiting embodiment, the arm rests 46 may be movable between a plurality of pre-determined or configurable positions.

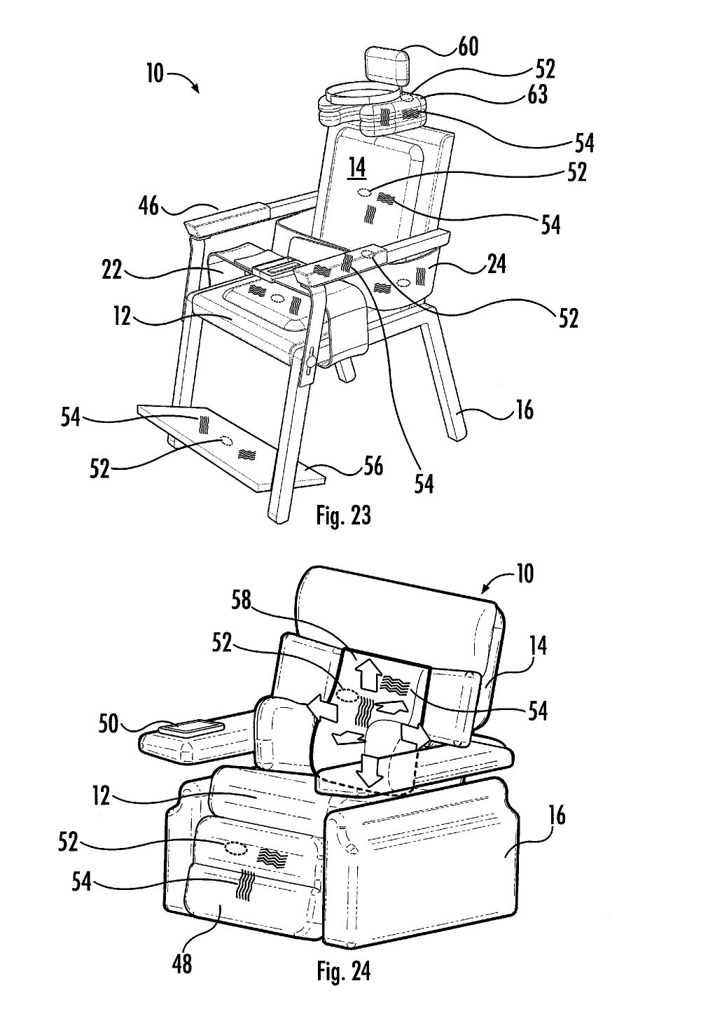

In another preferred and non-limiting embodiment, the arm rests 46 may be padded to provide a soft resting surface for the user's forearms. With reference to FIG. 23, the arm rests 46 optionally include a massage and/or heating/cooling function. For example, the arm rests 46 may be provided with a vibrator/massager 52 to massage the user's forearms while the user is in a seated position. Alternatively, or in addition, the arm rests 46 may have a built-in heating/cooling pad 54 to provide a heating/cooling function to the user's forearms. Each of the vibrator/massager 52 and the heating/cooling pad 54 is desirably controlled by the control panel 50. The vibrator/massager 52 and the heating/cooling pad 54 may be built-in or removable. By way of an example, the control panel 50 may control the intensity and duration of the massage and/or heating/cooling function. The operation of each of the vibrator/massager 52 and the heating/cooling pad 54 may be pre-programmed. Still further, all or a portion of the interface or contact surfaces of the device 10 may provide the massage function, a heated surface, a cooled surface, and the like.

With reference to FIG. 24, a lower leg support 48 is illustrated. The lower leg support 48 provides support for the user's calves during use of the device 10. The lower leg support 48 may be formed unitarily with the seat base 12, or it may be provided as a separate component attached to the frame 16. The lower leg support 48 may be movable relative to the seat base 12. The movement of the lower leg support 48 may be accomplished manually or by way of a folding mechanism (not shown), such as an electric motor. The operation of the folding mechanism is desirably controlled through the control panel 50.

In one preferred and non-limiting embodiment, the lower leg support 48 is padded with a soft material, such as a foam material, to provide a comfortable resting surface for the user's calves. Alternatively, the lower leg support 48 may include a firm material to provide solid support surface for the user's calves. In another preferred and non-limiting embodiment, the lower leg support 48 may be formed as two separate leg supports 48 shaped to receive each of the user's calves. In this embodiment, the separate leg supports 48 at least partially surround and grip each of the user's calves. The lower leg support 48 optionally includes a massage and/or heating/cooling function. For example, the lower leg support 48 may be provided with a vibrator/massager 52 to massage the user's calves while the user is in a seated position. Alternatively, or in addition, the lower leg support 48 may have a built-in heating/cooling pad 54 to provide a heating/cooling function to the user's calves. Each of the vibrator/massager 52 and the heating/cooling pad 54 is desirably controlled by a control panel 50. The vibrator/massager 52 and the heating/cooling pad 54 may be built-in or removable. By way of an example, the control panel 50 may control the intensity and duration of the massage and/or heating/cooling function. The operation of each of the vibrator/massager 52 and the heating/cooling pad 54 may be pre-programmed.

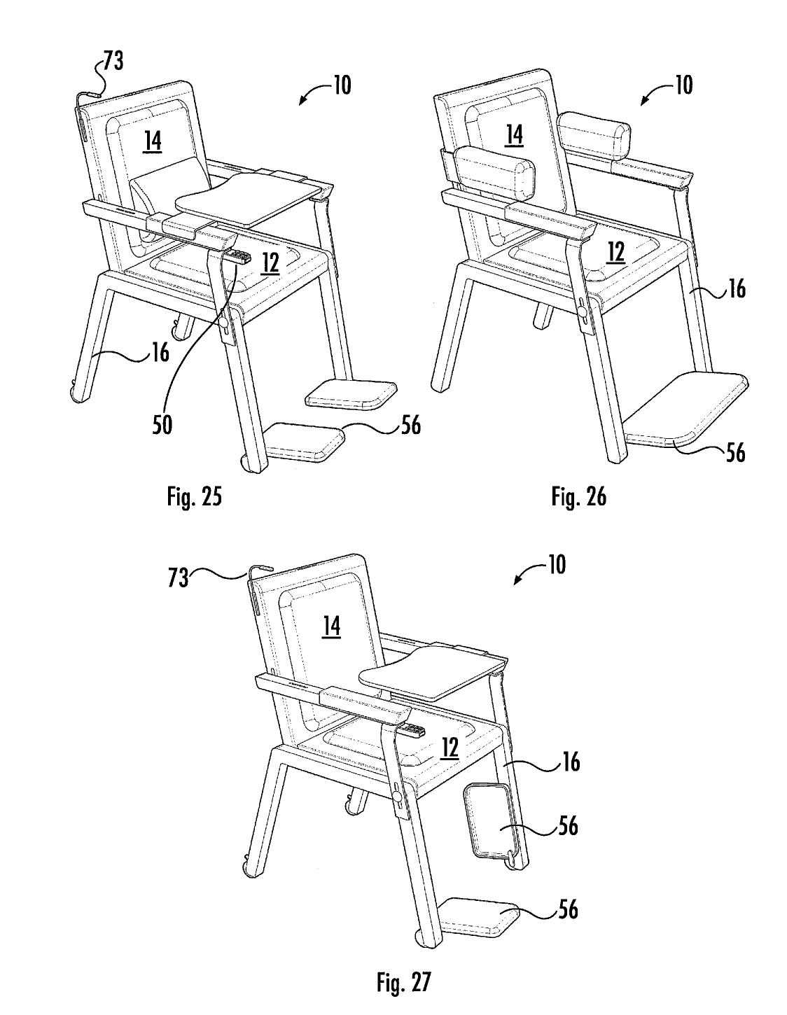

With reference to FIGS. 23 and 25-27, a foot rest 56 may be provided for supporting the user's feet while in a seated position. The foot rest 56 may be stowable between a folded position and an unfolded position. In a folded position, such as shown in FIG. 27, the foot rest 56 is folded such that it does not present an obstruction to the user while the user is sitting down or standing up from the device 10. In an unfolded position, such as shown in FIGS. 25-26, the foot rest 56 is unfolded such that the user may place his/her feet on the foot rest 56. The folding/unfolding of the foot rest 56 may be accomplished manually or by way of a folding mechanism (not shown), such as an electric motor. The operation of the folding mechanism is desirably controlled through the control panel 50 (FIG. 25). The foot rest 56 may be folded/unfolded, or moved side-to-side and front-to-back to adjust its position to accommodate the user's foot.

The foot rest 56 optionally includes a massage and/or heating/cooling function. For example, the foot rest 56 may be provided with a vibrator/massager 52 to massage the user's feet while the user is in a seated position (FIG. 23). Alternatively, or in addition, the foot rest 56 may have a built-in heating/cooling pad 54 to provide a heating/cooling function to the user's feet (FIG. 23). Each of the vibrator/massager 52 and the heating/cooling pad 54 is desirably controlled by the control panel 50. By way of an example, the control panel 50 may control the intensity and duration of the massage and/or heating/cooling function.

With reference to FIG. 24, the device 10 includes an adjustable lumbar support 58 provided on the seat back 14. The lumbar support 58 may be formed unitarily with the seat back 14, or it may be provided as a separable component. The lumbar support 58 is configured for adjustable movement in order to conform to the user's lumbar region. For example, the lumbar support 58 may be configured for up-down and/or side-to-side relative to the seat back 14. Additionally, the lumbar support 58 may be movable toward or away from the seat back 14. The movement of the lumbar support 58 may be accomplished manually or by way of a folding mechanism (not shown), such as an electric motor. The operation of the folding mechanism is desirably controlled through the control panel 50.

In one preferred and non-limiting embodiment, the lumbar support 58 is padded with a soft material, such as a foam material, to provide a comfortable resting surface for the user's lumbar region. Alternatively, or in addition, the lumbar support 58 may be covered in a high friction material to increase a frictional force between the user's lumbar region and the lumbar support 58. The lumbar support 58 may further include at least one inflatable member that is inflatable (by the user or by a pump controllable through the control panel 50) to conform to the user's lumbar region. The lumbar support 58 optionally includes a massage and/or heating/cooling function. For example, the lumbar support 58 may be provided with a vibrator/massager 52 to massage the user's lumbar region while the user is in a seated position. Alternatively, or in addition, the lumbar support 58 may have a built-in heating/cooling pad 54 to provide a heating/cooling function to the user's lumbar region. Each of the vibrator/massager 52, the heating/cooling pad 54 is desirably controlled by a control panel 50. The vibrator/massager 52 and the heating/cooling pad 54 may be built-in or removable. By way of an example, the control panel 50 may control the intensity and duration of the massage and/or heating/cooling function. The operation of each of the vibrator/massager 52 and the heating/cooling pad 54 may be pre-programmed.

Referring back to FIG. 4, a head/neck rest 60 is illustrated. The head/neck rest 60 may be unitary with the seat back 14, as shown in FIG. 1, or it may be provided as a separate component, as shown in FIG. 4. When provided as a separate component, the head/neck rest 60 may be removably attachable to the seat back 14 or the frame 16. The head/neck rest 60 is configured for adjustable movement in order to conform to the user's head and/or neck. For example, the head/neck rest 60 may be configured for up-down and/or side-to-side relative to the seat back 14. Additionally, the head/neck rest 60 may be movable toward or away from the seat back 14. The movement of the head/neck rest 60 may be accomplished manually or by way of a folding mechanism (not shown), such as an electric motor. The folding mechanism may also be embodied as an inflatable member that is inflatable to move the head/neck rest 60 in a desired direction. The operation of the folding mechanism is desirably controlled through the control panel 50.

In one preferred and non-limiting embodiment, the head/neck rest 60 is padded with a soft material, such as a foam material, to provide a comfortable resting surface for the user's head/neck area. Alternatively, or in addition, the head/neck rest 60 may be covered in a high friction material to increase a frictional force between the user's head/neck and the head/neck rest 60. The head/neck rest 60 optionally includes a massage and/or heating function. For example, the head/neck rest 60 may be provided with a vibrator/massager 52 to massage the user's head and/or neck while the user is in a seated position. Alternatively, or in addition, the head/neck rest 60 may have a built-in heating/cooling pad 54 to provide a heating/cooling function to the user's head and/or neck. Each of the vibrator/massager 52 and the heating/cooling pad 54 is desirably controlled by a control panel 50. The vibrator/massager 52 and the heating/cooling pad 54 may be built-in or removable. By way of an example, the control panel 50 may control the intensity and duration of the massage and/or heating/cooling function. The operation of each of the vibrator/massager 52 and the heating/cooling pad 54 may be pre-programmed or user configurable.

With reference to FIG. 18, the control panel 50 may have a graphical user interface 66 for inputting various commands to control the operation of the device 10. For example, the interface 66 may have a visual representation of the device 10 along with touch-sensitive panels that operate various features of the device 10, such as the massager 52 or the heating/cooling pad 54. The interface 66 may also be used to control the automated movement of the seat base 12 and/or the seat back 14, as will be described in detail hereinafter. It is envisioned that the control panel 50 may be used to control any of the features, functions, and components discussed herein, and additionally, the interface 66 may be in the form of an application that can be executed and/or utilized in or on a third party device. For example, a computer, pad computer, laptop, smart phone, or any other portable computing device can be programmed or loaded with the appropriate software or firmware to provide the interface 66 to the user. Accordingly, the user may use his or her existing device to control the various features, functions, or components of the device 10. For example, the device 10 may be equipped with reading lights 73 (shown in FIGS. 25 and 27), speakers (not shown), or screens (not shown) that are controlled or controllable through the interface 66. Similarly, the various components of the device 10 can be controlled through the integration of the interface 66 with other applications or interfaces on an existing computer (e.g., the control panel 50). Therefore, fully integrated wireless communication may be provided to the device 10, thus making the device 10 a Smart Chair. Still further, the control panel 50 or third party device may include profile settings on the interface 66, such that the device 10 has the ability to reconfigure or adjust the various features, functions, and components of the device 10 to previous settings according to the identification of the user.

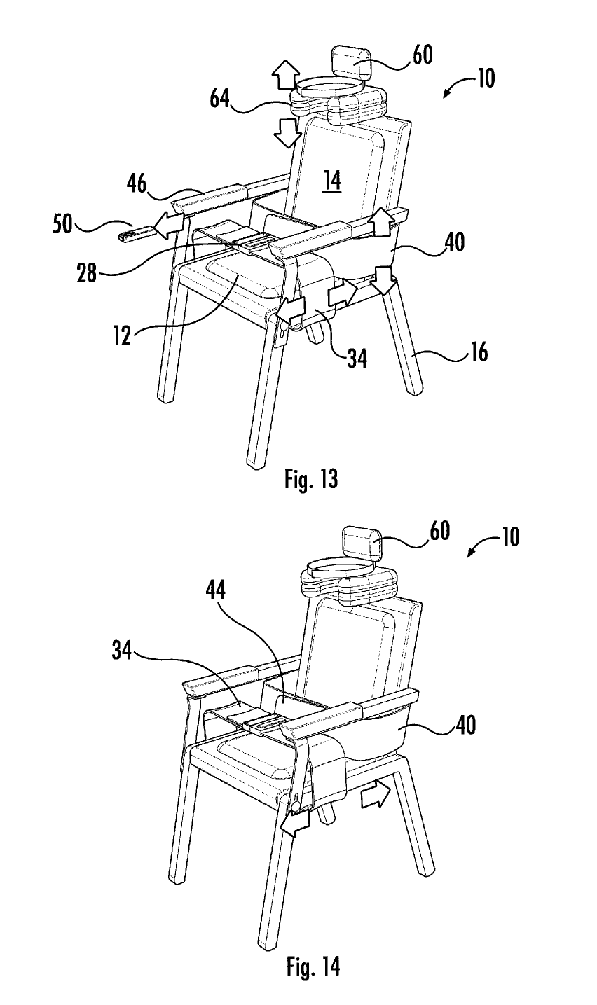

With reference to FIGS. 4 and 13, the head/neck rest 60 is provided with a chin strap 62 to secure the user's head and neck from movement relative to the head/neck rest 60. The head/neck rest 60 also has a pair of side supports 64 to support the side of the user's head and/or neck. For example, the side supports 64 may extend to envelop at least a portion of the side of the user's head and/or neck. In the embodiment shown in FIG. 23, a neck support 63 of the head/neck rest 60 is configured to extend around at least a portion of the user's neck. The side supports 64 may be adjustable, for example by being spring-loaded, such that they are deflectable to receive the user's head therebetween. Alternatively, or in addition, the side supports 64 may be hingedly connected to a portion of the device 10 such that the side supports 64 may be hingedly rotated to receive the user's head therebetween. In yet another embodiment, the head/neck rest 60 may have an inflatable member that is inflatable to form to the shape of the user's head. The chin strap 62 and the side supports 64 may be padded with a soft material, such as a foam material, and covered with a high-friction covering to provide a comfortable resting surface for the user's chin, head, and neck.

To relieve neck pain, user places his or her head/neck between the side supports 64 of the head/neck rest 60 such that the side supports envelop at least a portion of the user's head. Alternatively, in case of the head/neck rest 60 shown in FIG. 23, the user places his or her neck such that at least a portion of the user's neck is enveloped by the neck support 63 of the head/neck rest 60. In either embodiment, the head/neck rest 60 may move up and down and/or side to side, to provide a gentle stretch and/or decompression of the upper spine and neck by gently pulling or pushing the head/neck away from the body, and then returning the head/neck to its original position. This push/pull motion may be achieved by moving the head/neck rest 60 upwards to apply upward pressure on the occipital bones at the back of the head and the mandibles in the front of the head, or by moving the head/neck rest 60 downward to apply downward pressure on the collarbones—in either case gently moving the head away from the rest of the body and then returning the head to its original position. Such movement may be pre-programmed and controlled at the control panel 50 or using the user interface 66, and the above-discussed safety mechanisms or arrangements may also be utilized. Further, it is envisioned that the head/neck rest 60 may be manufactured and sold as a standalone device, which can be removably attached to an existing chair or other surface. This would facilitate the user of the head/neck rest 60 separate and apart from the device 10, such as a retrofit item on an existing chair. Accordingly, the head/neck rest 60 may include the appropriate control and communication components to be separately controllable and configurable.

One or more handles 72 are provided on the device 10 to provide a gripping surface for the user while seating/unseating from the device 10. In one preferred and non-limiting embodiment, the one or more handles 72 may be provided on the arm rests, or the handles 72 may be connected directly to the frame. The one or more handles 72 may be foldable into the arm rests 46 such that they can be stowed when not in use. Alternatively, or in addition, the one or more handles 72 may be removably attached to the arm rests 46 or the frame 16 such that they can be removed when not in use.

With reference to FIG. 2A-2B, the device 10 may include one or more pairs of wheel sets 70 connected to the frame 16. The wheel sets 70 may be provided on a front portion and/or the rear portion of the frame 16 to facilitate movement of the device 10. Each wheel of the wheel set 70 is desirably lockable to prevent unintended movement of the device 10. The wheels of the wheel set 70 may be arranged on a caster (not shown) such that the wheel is rotatable about its vertical axis.

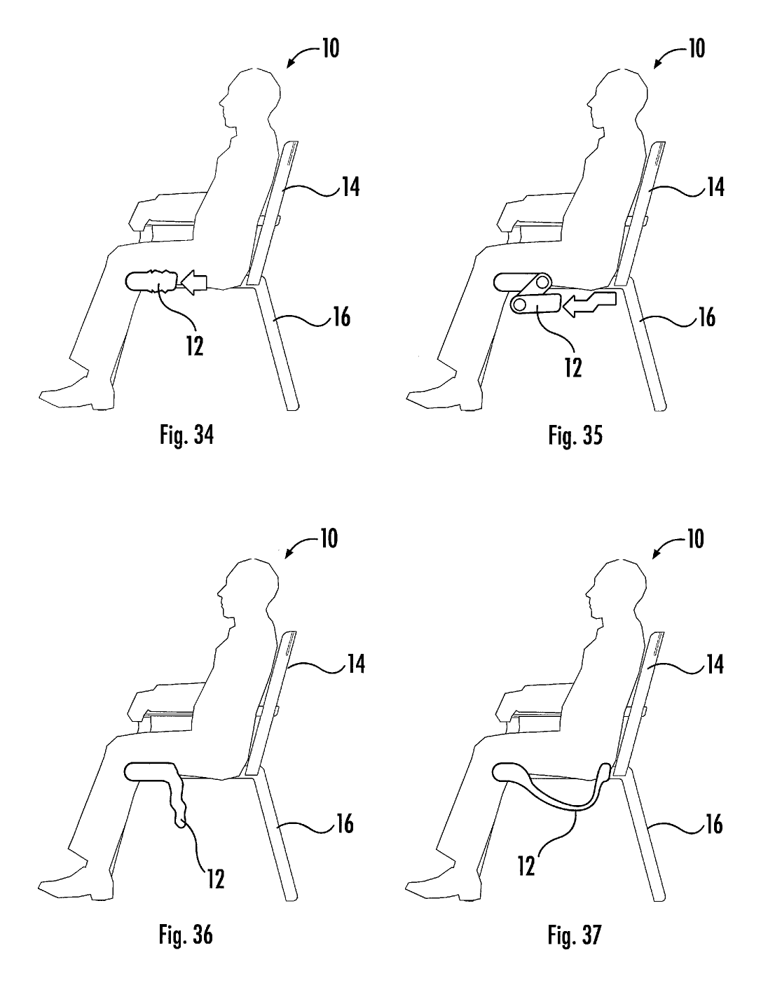

Having described the various components of the device 10, a method of operation of the device 10 for decompressing the user's spine will now be described. In one preferred and non-limiting embodiment, decompression of the user's spine is accomplished as a gentle stretch of the user's back by affecting relative movement of the seat base 12 and the seat back 14. this stretch may occur based upon the above-discussed restraint of the user's hips and/or torso from moving relative to the seat base 12 and the seat back 14, respectively, or alternatively, using frictional interfaces (as discussed hereinafter) between the user and the surfaces of the device 10. For example, with reference to FIGS. 30-37, the seat base 12 may be moved relative to the seat back 14 by moving at least a portion of the seat base 12 away from the seat back 14. This movement may be accomplished by dropping or moving at least a portion of the seat base 12 using a hinged or articulating arrangement (FIGS. 30-33 and 35), a sliding arrangement (FIG. 34), and/or a bladder or stretching arrangement (FIGS. 36 and 37).

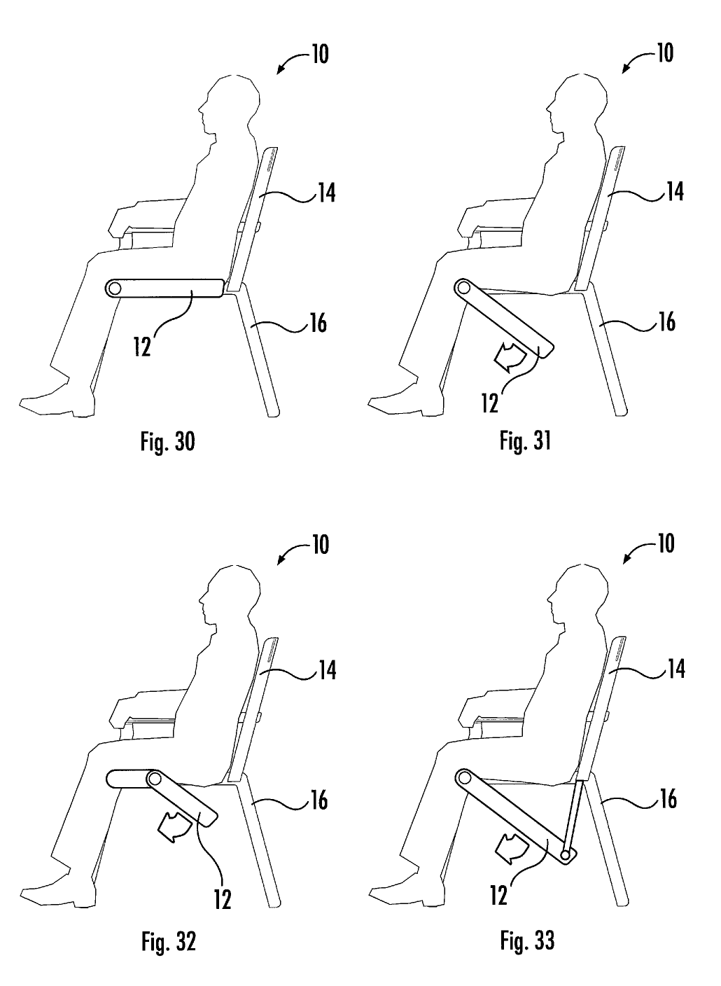

FIG. 30 illustrates the seat base 12 in an initial, non-lowered position. This may be a default orientation of the seat base 12 and the seat back 14 that allows the user to sit in the device 10 prior to use. In various preferred and non-limiting embodiments illustrated in FIGS. 31-37, at least a portion of the seat base 12 is lowered relative to the seat back 14. FIG. 31 illustrates an embodiment where the seat base 12 is lowered relative to the seat back 14, with the front portion 18 of the seat base 12 acting as a hinge. FIG. 32 illustrates an embodiment where the rear portion 20 of the seat base 12 is lowered relative to the front portion 18 of the seat base 12 and seat back 14, with the front portion 18 of the seat base 12 acting as a hinge. FIG. 33 illustrates that the seat base 12 may lower in one piece, with the front of the seat base 12 acting as a hinge, and including a stabilizer bar 76 to controlling the lowering the seat base 12. FIG. 34 illustrates that the rear portion 20 of the seat base 12 is retractable. FIG. 35 illustrates that the rear portion 20 of the seat base 12 is retractable, in a non-linear manner. FIGS. 36-37 illustrate that the rear portion of the seat base 12 may deflate or stretch/contract. While FIGS. 31-37 illustrate various preferred and non-limiting embodiments, any other arrangement in which at least a portion of the seat base 12 lowers to increase a distance between the rear portion 20 of the seat base 12 and the seat back 14 to allows decompression of the spine of the seated user may be used.

As the seat base 12 is moved relative to the seat back 14, the user's body is restrained by the first and second restraints 22, 24. In this manner, as the seat base 12 is lowered, the user's hips are restrained relative to the seat base 12 by the first restraint 22, while the user's torso is restrained by the second restraint 24. Alternatively, or in addition, as discussed below, another option is to utilize the frictional interfaces created between the user's clothes or skin and the device 10 to restrain the user's body for achieving the stretching motion. As the distance between the seat base 12 and the seat back 14 is gradually increased, the user's torso is elongated, thereby decompressing the user's spine. These same concepts and principles are equally applicable to the head/neck rest 60 component discussed above.

The seat base 12 is desirably movable relative to the seat back 14 and the frame 16. In a similar manner, the seat base 12 may be stationary relative to the seat back 14 and the frame 16, while the seat back 14 is movable relative to the seat base 12 and the frame 16.

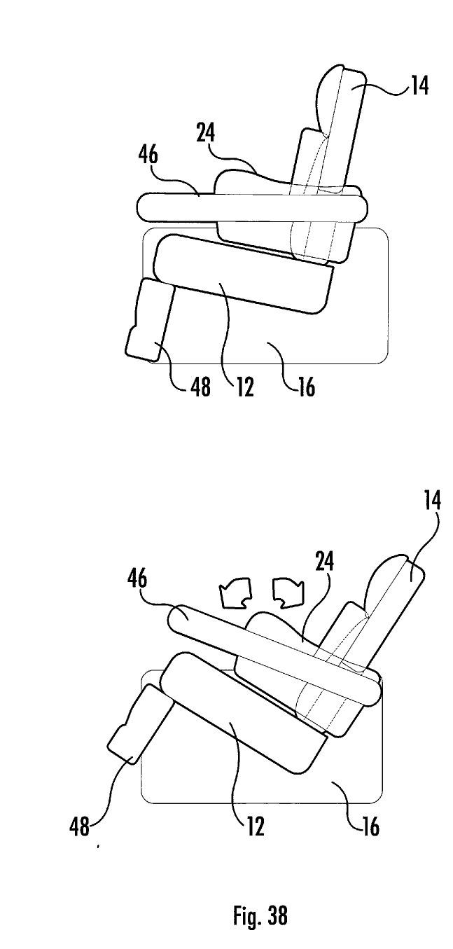

FIG. 38 illustrates the tilt capability of the device 10. The tilting is accomplished by simultaneously moving the seat base 12 and the seat back 14 at an angle relative to the frame 16. As the seat base 12 and the seat back 14 are tilted relative to the frame 16, the angular orientation between the seat base 12 and the seat back 14 is desirably kept constant. For example, in one preferred and non-limiting embodiment, the tilting motion may be adjustable to permit up to 90 degrees of rotation from an initial position to a maximum tilt position. During tilting of the device 10, the user remains oriented at the same seated position. Additionally, the remaining components of the device 10, such as the arm rests 46, lower leg support 48, and the foot rest 56 may tilt with the tilting of the seat base 12 and the seat back 14. By tilting the device 10, a frictional force is established between the seat back 14 and the user's back. This frictional force helps with the spinal decompression of the user in this seated position and relieves the gravitational force to enhance spinal decompression. This frictional interface is established between the user's clothes and/or skin and the material the seat back 14. Once tilted, the device 10 can be used in a manner described hereinabove. In addition, and when relying on the frictional interface to implement the back and/or neck decompression, the restraints 22, 24 may be excluded, disengaged, or removable from the device 10.

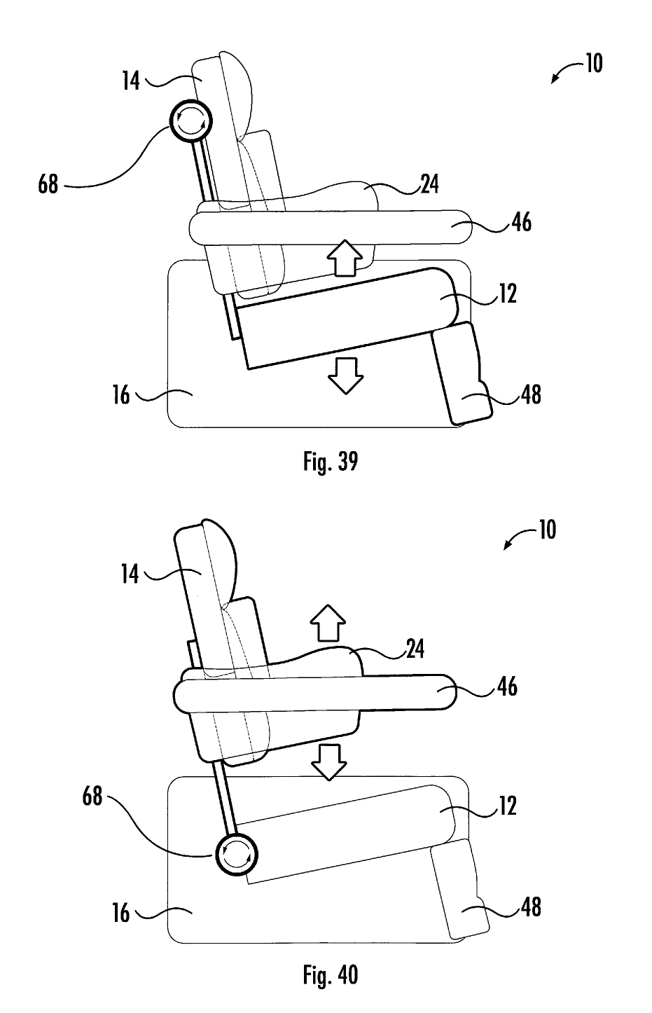

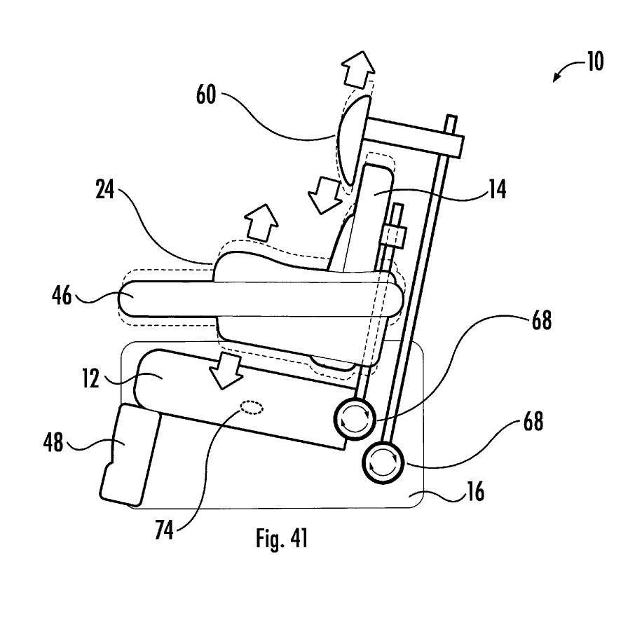

Movement of the device 10 may be accomplished either manually (e.g., by a handle or the user pushing on a portion of the seat base 12 or the seat back 14) or automatically (e.g., by a command input on the control panel 50). FIGS. 39-41 illustrate a motor-controlled embodiment of the device 10. At least one actuator 68, such as an electric motor, a hydraulic motor, or a pneumatic motor, is provided on the device 10 to adjust the position of various components. For example, the at least one actuator 68 is operative for moving at least a portion of the seat base 12 in an up-down direction relative to the seat back 14. During this movement, and in the embodiment of FIG. 39, the seat back 14 remains stationary, or it also moves away from the seat base 12 to increase the gap therebetween. Alternatively, or in addition, a second actuator 68 may be provided to move at least a portion of the seat back 14 in an up-down direction relative to the seat base 12, as illustrated in the embodiment of FIG. 40. During this movement, the seat base 12 remains stationary, or it also moves away from the seat back 14 to increase the gap therebetween. The at least one actuator 68 is desirably connected to the frame 16, the seat base 12, or the seat back 14. As the seat base 12 is lowered and/or as the seat back 14 is raised, the arm rests 46 may be raised or lowered to provide support for the user. A separate actuator 68 can be provided for controlling the movement of the head/neck rest 60, as illustrated in FIG. 41. Additionally, at least one sensor 74, such as a weight sensor, may be operatively coupled with the actuator 68. The at least one sensor 74 senses the user's weight, which may be used as a parameter for controlling the operation of the actuator 68. For example, the tilting angle of the device 10 or the amount of relative movement between the seat base 12 and the seat back 14 may be dependent on the user's weight.

In this manner, the present invention provides an apparatus and method for spinal decompression. Further, the present invention provides an apparatus and method for relieving or addressing back and/or neck pain through the use of such spinal decompression.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the description. For example, it is to be understood that the present invention contemplates that, to the extent possible, one or more features of any embodiment can be combined with one or more features of any other embodiment.

What is claimed is:

1. A device for relieving back and/or neck pain of a seated user through spinal decompression, the device comprising:
a frame;
a seat base connected to the frame, the seat base having a front portion and a rear portion; and
a seat back connected to the frame, the seat back extending from the rear portion of the seat base;
wherein at least one of the seat base and the seat back is movable relative to the other of the seat base and the seat back to increase a distance between the seat base and the seat back for decompressing a spine of the seated user.

2. The device of claim 1, wherein at least a portion of the seat back raises relative to the seat base.

3. The device of claim 1, wherein at least a portion of the seat base lowers relative to the seat back.

4. The device of claim 1, wherein the rear portion of the seat base lowers relative to the front portion of the seat base and the seat back.

5. The device of claim 1, further comprising a restraint configured for restraining hips of the user relative to the seat base.

6. The device of claim 5, wherein the restraint comprises at least one of an adjustable lap belt and an adjustable lap pad.

7. The device of claim 1, further comprising a restraint configured for restraining a torso of the user relative to the seat back.

8. The device of claim 7, wherein the restraint comprises at least one of an adjustable torso supports for supporting the torso of the user and an adjustable torso strap for wrapping around the torso of the user.

9. The device of claim 1, further comprising a first restraint configured for restraining hips of the user relative to the seat base, and a second restraint configured for restraining a torso of the user relative to the seat back.

10. The device of claim 9, wherein the first and second restraints comprise a locking mechanism.

11. The device of claim 1, further comprising arm rests for supporting forearms of the user.

12. The device of claim 1, further comprising a lower leg support for supporting calves of the user.

13. The device of claim 1, further comprising an adjustable lumbar support in the seat back.

14. The device of claim 1, further comprising a head/neck rest connected to the seat back.

15. The device of claim 14, wherein the head/neck rest is movable relative to the seat back for decompressing the neck of the user.

16. The device of claim 1, wherein at least one of the seat base and the seat back tilt relative to the frame.

17. The device of claim 1, further comprising an interface on at least one computing device programmed or configured to facilitate user control of at least one function or component of the device.

18. The device of claim 1, further comprising at least one of a massager, a heater, and a cooling device.

19. The device of claim 1, further comprising an actuator operatively coupled to one of the seat base and the seat back for moving the seat base or the seat back to increase a distance therebetween.

20. The device of claim 19, wherein the actuator is at least one of the following: an electric, a hydraulic, a pneumatic device, or any combination thereof.

21. The device of claim 19, wherein the actuator is operatively coupled to the head/neck support.

22. A device for relieving back and/or neck pain of a seated user through spinal decompression, the device comprising:
a frame;
a seat base connected to the frame, the seat base having a front portion and a rear portion;
a seat back connected to the frame, the seat back extending from the rear portion of the seat base; and
an actuator operatively coupled to one of the seat base and the seat back for moving the seat base or the seat back to increase a distance between the seat base and the seat back, and
wherein the seat base and the seat back tilt relative to the frame.

23. The device of claim 22, further comprising a restraint configured for restraining hips of the user relative to the seat base.

24. The device of claim 22, further comprising a restraint configured for restraining a torso of the user relative to the seat back.

25. The device of claim 22, further comprising a first restraint configured for restraining hips of the user relative to the seat base, and a second restraint configured for restraining a torso of the user relative to the seat back.

26. A method for relieving back and/or neck pain of a seated user through spinal decompression, the method comprising:
providing a chair, comprising:
a frame;
a seat base connected to the frame, the seat base having a front portion and a rear portion; and
a seat back connected to the frame, the seat back extending from the rear portion of the seat base; and
moving one of the seat base and the seat back relative to the other of the seat base and the seat back to increase a distance between the seat base and the seat back to decompress the spine of the seated user.

27. The method of claim 26, further comprising restraining at least one of hips of the user a torso of the user.
